(19) United States
(12) Patent Application Publication
(10) Pub. No.: US 2010/0118289 A1
(43) Pub. Date: May 13, 2010

(54) MEMBER USED IN IMMERSION EXPOSURE APPARATUS AND IMMERSION EXPOSURE APPARATUS

(75) Inventor: Makoto Ogusu, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/605,951

(22) Filed: Oct. 26, 2009

(30) Foreign Application Priority Data
Nov. 12, 2008 (JP) 2008-289998

(51) Int. Cl. G03B 27/58; G03B 27/32

(52) U.S. Cl. 355/72; 355/77

(57) ABSTRACT

A member of an immersion exposure apparatus for exposing an image of a pattern of an original on a substrate via a liquid, and configured to be in contact with the liquid, includes a base portion, and a plurality of protruded portions provided on the base portion, wherein a contact angle θ of a material of a surface of the protruded portions before the protruded portions are exposed with light from a light source is larger than 90 degrees with respect to the liquid, and wherein, a value obtained by dividing a sum of a surface area of a face of the base portion on which the plurality of protruded portions are provided and the surface area of the plurality of protruded portions, by an area of the face of the base portion on which the plurality of protruded portions are provided, is r, r>1/|cos θ| is satisfied.

### BACKGROUND OF THE INVENTION

1. Field of the Invention

The present invention relates to a member used in an immersion exposure apparatus, and an immersion exposure apparatus.

2. Description of the Related Art

In the production processes for semiconductor devices formed with an ultrafine pattern, such as a large scale integrated (LSI) circuit or very large scale integrated (LSI) circuit (VLSI) circuit, measures for increasing the fineness of the circuit patterns by the exposure apparatus have been carried out along with improvements in the integration density of the semiconductor devices. Projection exposure using an immersion method has been attracting attention as a method for improving the resolution of an exposure apparatus.

Conventionally, the immersion method is an exposure method in which a liquid is filled between a projection optical system and a wafer instead of gaseous matter. In this immersion method, it is necessary to support the liquid even when exposing the wafer periphery. For that purpose, a stage apparatus is used, which includes a component (flush plate) having approximately the same height as the wafer.

WO 05/055296 discusses a technique in which a component is arranged on the periphery of the wafer to support the liquid. During the exposure operation, the liquid moves on the component supporting the liquid while being held under the optical system. To allow the liquid to move while being held under the optical system, the component supporting the liquid needs to be water-repellency, and the component surface also needs to have a contact angle of predetermined value or more.

Differences in water-repellency are known to occur due to a fine uneven structure. Especially, a state where water does not penetrate into the fine uneven structure (gas is enclosed), which is called “structural water repellency”, is known to exhibit high water repellency.

C. Ishino, K. Okumura, and D. Quere discuss in “Wetting Transitions on Rough Surface”, Europhys. Lett., 68 (3), pp 419 to 425, 2004, the relationship between the fine uneven structure and various phenomena ranging from high water repellency to hydrophilicity.

Further, Japanese Patent Application Laid-Open Nos. 2006-319065, 2005-150734, and 2007-305973 discuss forming a fine structure on an auxiliary plate (holding member) formed on a wafer periphery in an exposure apparatus.

When exposing the pattern as far as a substrate periphery in the immersion exposure apparatus, exposure light is irradiated even as far as the flush plate supporting the liquid. Recently, the light source used in exposure apparatuses has a large energy due to its short wavelength, which can damage the water-repellant material. More specifically, even if the flush plate is formed of a material having water-repellent surface, the water-repellency of the flush plate deteriorates due to the exposure light irradiated during use. Consequently, the durability of the flush plate is poor.

In “Wetting Transitions on Rough Surface”, Europhys. Lett., 68 (3), pp 419 to 425, 2004, by C. Ishino, K. Okumura, and D. Quere, only the relationship between the fine uneven structure and various liquid holding states is discussed. This document does not discuss the application of the fine uneven structure in the exposure apparatus.

In Japanese Patent Application Laid-Open Nos. 2006-319065, 2005-150734, and 2007-305973, the fine uneven structure is formed on the flush plate for supporting the liquid.

For example, in Japanese Patent Application Laid-Open No. 2006-319065, a fifth embodiment discusses a surface having an uneven structure. According to the discussed contents, the interval between the protruded portions is in the range of 5 to 200 μm, and the height of the protruded portions is in the range of 5 to 100 μm. However, this document does not discuss the width of the protruded portions, nor does it discuss the ratio (duty) between the widths of the protruded portions with respect to the interval. Further, this document contains no discussion about the ratio (aspect) of the height based on the width of the protruded portions as a standard.

Further, in Japanese Patent Application Laid-Open No. 2005-150734, in the embodiments it is discussed that the appropriate condition for the array interval of the fine structure is 50 to 500 μm, and for the height is 50 to 200 μm. However, Japanese Patent Application Laid-Open No. 2005-150734 also does not discuss the values corresponding to the duty and the aspect, such as the cross-sectional shape of the fine structure.

Moreover, in Japanese Patent Application Laid-Open No. 2007-305973, Equation 2 illustrates a relational expression of the contact angle on a surface having a protruded portion (corresponding in Japanese Patent Application Laid-Open No. 2007-305973 to a surface having “asperity”). This document describes a value r, which is obtained by dividing a sum value of the surface area of the face of a base portion on which a plurality of protruded portions are provided and the surface area of the plurality of protruded portions, by the surface area of the face of the base portion on which the plurality of protruded portions are provided (corresponding in Japanese Patent Application Laid-Open No. 2007-305973 to the “roughness coefficient r”).

However, while it is discussed in the embodiments that fakir states are a necessary and important state, the embodiments also describe that such states are generally “metastable” fakir states that revert to a Wenzel state upon application of agitation or pressure to the fluid.

More specifically, Japanese Patent Application Laid-Open No. 2007-305973 does not discuss a technology for realizing a stable fakir state. The term “fakir state” refers to a state where the liquid contacts only the tips of the fine structure. In the present application, this is referred to as an “air trap state”. Further, while Japanese Patent Application Laid-Open No. 2007-305973 discusses that good durability of the hydrophobic property (water-repellency) can be provided by forming the protruded portions with sufficient depth (“thickness”), this document does not discuss the specific dimensions or conditions for maintaining the hydrophobic property to a maximum level.

### SUMMARY OF THE INVENTION

The present invention is directed to a member used in an immersion exposure apparatus, which exhibits good water-repellency even when irradiated with exposure light over a long period of time. The present invention is also directed to an immersion exposure apparatus using such a member, and a method for producing a device using that immersion exposure apparatus.

According to an aspect of the present invention, a member which is used in an immersion exposure apparatus for exposing an image of a pattern of an original on a substrate via a liquid, and which is in contact with the liquid, includes a base portion, and a plurality of protruded portions provided on the base portion, wherein a contact angle of a material of a surface of the protruded portions before the protruded portions are exposed with light from a light source is larger than 90 degrees with respect to the liquid, and wherein, if the contact angle is θ, and a value obtained by dividing a value found by adding a surface area of a face of the base portion on which the plurality of protruded portions is provided and the surface area of the plurality of protruded portions, by the surface area of the face of the base portion on which the plurality of protruded portions is provided, is r, then r>1/|cos θ| is satisfied.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram of a fine structure.

FIG. 2 is a top view of a fine structure.

FIG. 3 illustrates a fall angle in an air trap state and a Wenzel state.

FIG. 4 illustrates a relationship between duty ratio and fall angle.

FIG. 5 illustrates a gas-liquid interface.

FIG. 6 is a schematic diagram of an exposure apparatus according to a first exemplary embodiment.

FIG. 7 is a plan view of a wafer stage according to a second exemplary embodiment.

FIG. 8 illustrates the vicinity of an immersion area.

### DESCRIPTION OF THE EMBODIMENTS

Various exemplary embodiments, features, and aspects of the invention will be described in detail below with reference to the drawings.

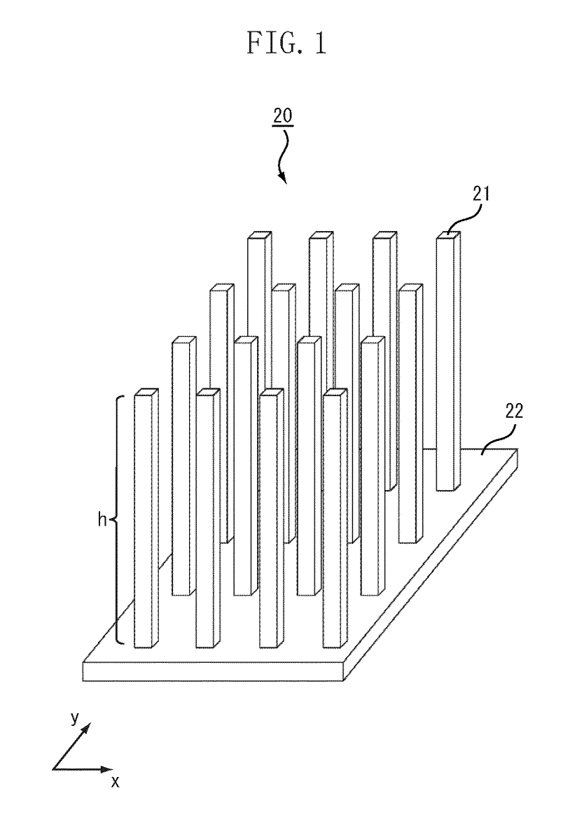

FIG. 1 is a schematic diagram of a fine structure according to the present invention. As illustrated in FIG. 1, a fine structure 20 has protruded structures 21 and a base portion 22.

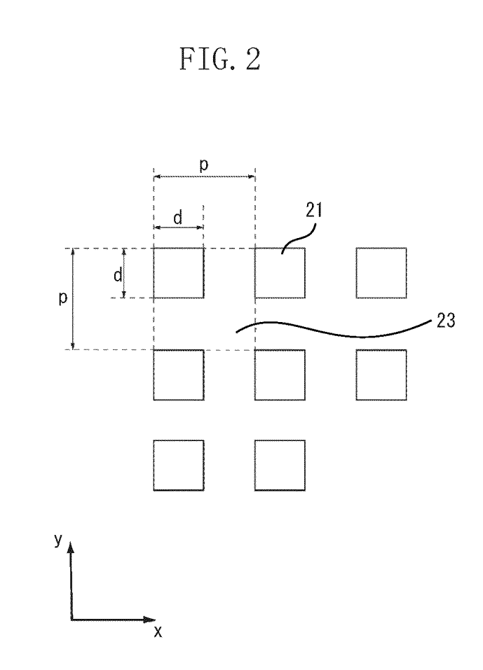

FIG. 2 illustrates the fine structure 20 from above. Each of the protruded structures 21 has a quadrangular prism shape, with a width d (constant). A plurality of protruded structures 21 are respectively arranged in the x and y directions at a pitch (period) p (constant).

A standard area 23 (p×p) including a protruded structure 21 is defined by a surface area expansion factor r, which is a value obtained by dividing a surface area a by the surface area (p×p) of the standard area 23. The surface area a is the total of the upper and side faces of the protruded structures 21 and the surface area of the base portion 22 on which the protruded structures 21 are not formed. Expressed as an equation, a is d×d (surface area of the upper face of the protruded structures 21)+4×d×h (surface area of the side faces of the protruded structures 21)+(p×p−d×d) (the surface area of the base portion 22 on which the protruded structures 21 are not formed).

The pitch p of the protruded structures 21 may be about 1 to 10 μm, though it is not limited to the value. Further, the protruded structures are not limited to a quadrangular prism shape. For example, the protruded structures may alternatively be a truncated cone shape.

As a result of investigations concerning the fine structure, the present inventor discovered that if exposure light is irradiated on a fine uneven structure, there is a phenomenon where deterioration of water-repellency reaches saturation, and desired characteristics can continue to be satisfied.

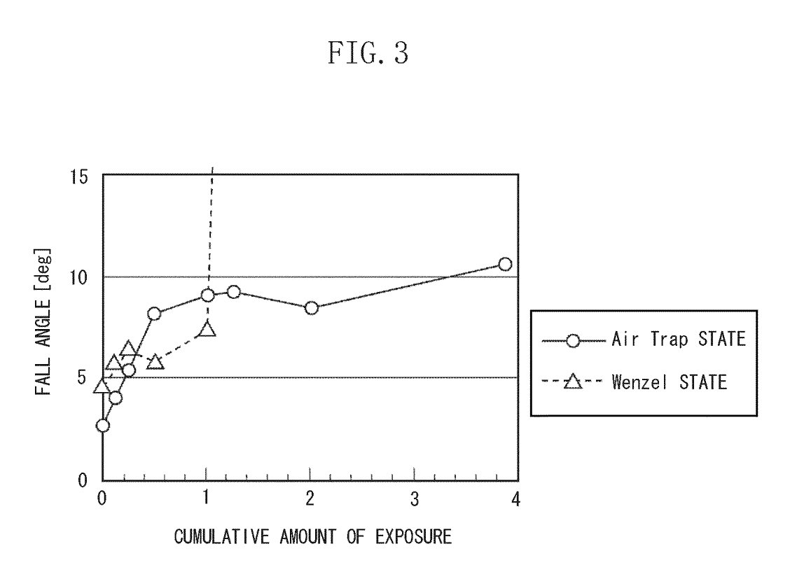

FIG. 3 illustrates experiment results. In the present experiment, the pitch p of the protruded structures 21 was 2 μm, the duty ratio (d/p) was 0.25, the height h of the protruded structures 21 was 10 μm, and the surface area expansion factor r was 6. The duty ratio is a value obtained by, when observing along a cross-section parallel to a side of the quadrangular prism of the protruded structures 21, dividing the width (d) of the protruded structures by a repeating period (p) in which the protruded structures are arranged. Further, a TC coat is formed on the surface of the fine structure. This TC coat is a water-repellent film manufactured by Dupont.

The horizontal axis of FIG. 3 represents the cumulative amount of exposure, and the vertical axis represents the fall angle, which acts as an index representing the level of water-repellency. The cumulative amount of exposure is normalized by the life of the water-repellant coat when exposed in the below-described Wenzel state.

If a droplet of a fixed amount is placed on a specimen surface, and the specimen is tilted, the droplet will eventually roll and fall off from the specimen surface. The angle from the horizontal face of the specimen surface when this droplet falls is defined as the fall angle. The fall angle is influenced by the specimen surface as well as the amount of the droplet. For the measurement of the drop angle, pure water was used as the liquid, and the droplet amount was 50 μl.

The state where air is held among the protruded structures and the liquid only contacts the tips of the protruded structures is referred to here as an “air trap state”. Conversely, the state where the liquid has infiltrated into the space among the protruded structures and fills that space is referred to here as a “Wenzel state”.

FIG. 3 illustrates the results of measuring the fall angle at each cumulative amount of exposure by irradiating exposure light on the fine structure 20 for both the air trap state and Wenzel state.

In the Wenzel state, although the deterioration in water-repellency would seem to be saturated, compared with the results of irradiating in the air trap state, the fall angle is larger at lower cumulative amounts of exposure. More specifically, it can be seen that life is shorter due to exceeding the desired fall angle range at lower cumulative amounts of exposure.

For an immersion exposure apparatus, a smaller fall angle is better. For example, a fall angle of about 20 degrees or less is desirable. It is thought that a small fall angle was measured even after irradiation of the exposure light in the Wenzel state due to the fact that during the period when the water-repellency of the fine structure surface was high, the surface was in the air trap state when the fall angle is measured.

However, if the water-repellency deteriorates due to the irradiation of the exposure light, the air trap state cannot be maintained, whereby it is thought that the liquid infiltrates among the protruded structures. If the liquid infiltrates among the protruded structures, a small fall angle is no longer exhibited.

The deterioration of the water-repellency is thought to proceed even if the exposure light is irradiated in the air trap state. It is thought that the water-repellency no longer exhibits the desired contact angle due to the same mechanism as for the exposure results in the Wenzel state, whereby the water-repellency reaches the end of its life. What is important is that to reliably extend the life of the water-repellency, when the exposure light is irradiated, the air trap state be reliably secured.

Next, the conditions for reliably expressing the air trap state were investigated. Consequently, the conditions concerning the surface of the fine structure were discovered. First, it is important that the contact angle of the surface of the fine structure is 90 degrees or more.

Further, there is a condition corresponding to the contact angle of the surface of the fine structure. According to Patent Document 1, a contact angle θw when in a Wenzel state can be expressed by the following equation,

cos θw=r·cos θ (1)

wherein r represents the surface area expansion factor, and θ represents the contact angle of the surface of the fine structure. When the value of the right side of the equation is greater than 1, the contact angle equation for the Wenzel state does not hold. Namely, the Wenzel state is not present. This can be expressed by the following Formula 2.

r>1/|cos θ| (2)

More specifically, if the inverse of the absolute value of the cosine of the contact angle of the surface of the fine structure is less than the surface area expansion factor r, the air trap state is stable. If the above condition (formula (2)) is not satisfied, either the Wenzel state or the air trap state can occur.

Namely, the life of the water-repellency of the fine structure is not always extended. Rather, since the surface energy of the liquid in the Wenzel state is smaller than the surface energy of the liquid in the air trap state, the Wenzel state occurs more easily from an external action.

In this case, since the exposure light can also be irradiated in the Wenzel state, the life cannot be reliably extended.

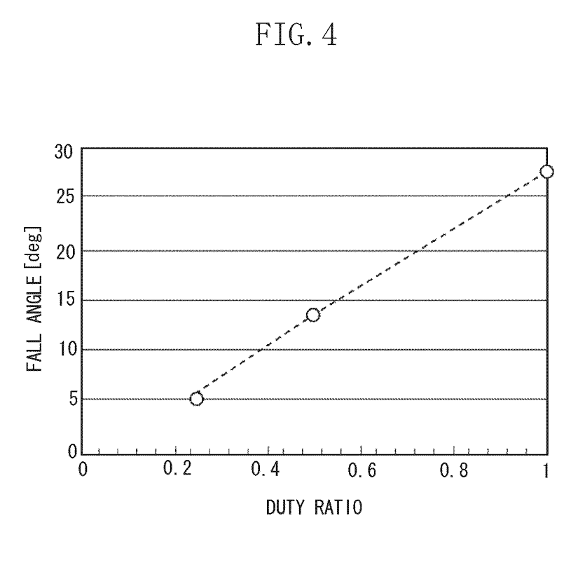

Further, the conditions for exhibiting the desired fall angle were discovered as a result of investigating the factors that determine the fall angle. FIG. 4 illustrates the results of measuring the fall angle when deterioration is saturated by changing the duty ratio of the protruded structures 21. From FIG. 4, it can be seen that the fall angle changes depending on the duty ratio.

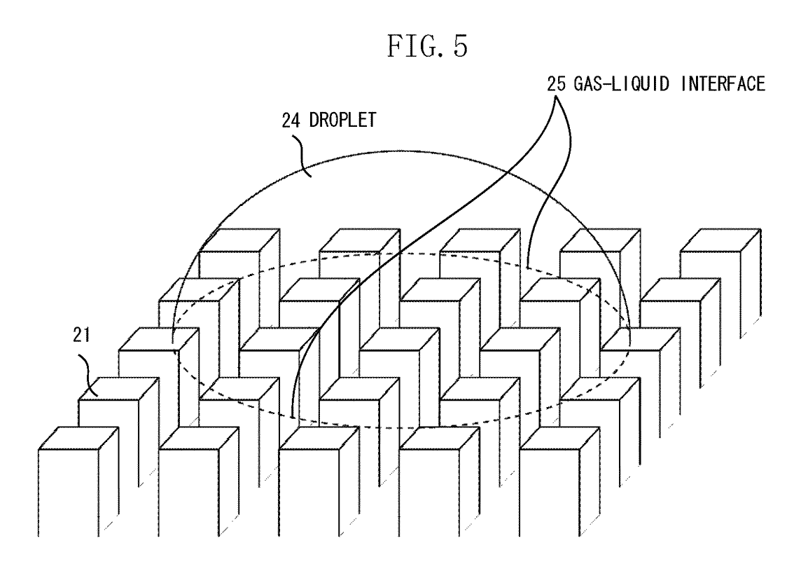

FIG. 5 illustrates a boundary line 25 (referred to as a gas-liquid interface) between a liquid and a gas, which can be defined on an object surface.

Since the fall angle is thought to be determined by the characteristics of the gas-liquid interface, there is no problem with thinking of the duty ratio by substituting it with the portion along the gas-liquid interface line where the material of the protruded structures and the liquid are in contact.

More specifically, if the duty ratio of the protruded structures decreases, the force supporting a droplet 24 (force preventing the droplet from falling) decreases by the same ratio as the duty ratio. Consequently, it is thought that the liquid moves even at a small fall angle. To realize a fall angle of about 20 degrees, it is known that the duty ratio has to be larger than 0 and less than or equal to 0.75.

According to the present exemplary embodiments, a member can be provided which exhibits good water-repellency even when exposure light is irradiated over a long period of time.

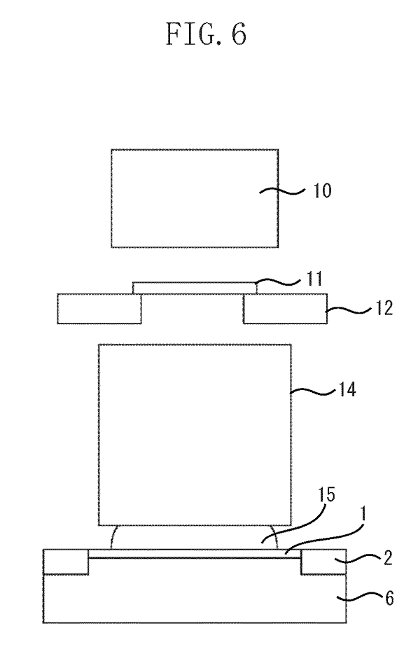

A first exemplary embodiment according to the present invention will now be described. FIG. 6 is a schematic diagram of an immersion exposure apparatus. The above-described fine structure 20 is provided on a holding member 2. For the liquid 15, pure water or a compound having a higher refractive index than water may be used.

An illumination optical system 10 illuminates a mask 11 using light from an exposure light source. Then, an image of a pattern of the mask 11 is projected and exposed onto a wafer 1 via a projection exposure system 14 and the liquid 15. During exposure, a wafer stage 6 positions the wafer 1 by moving the sequential location.

The holding member 2 is arranged on a periphery of the wafer 1 to support the wafer 1 and the liquid 15. Therefore, when an edge (outer periphery) portion of the wafer 1 is exposed, the exposure light is irradiated on the holding member 2 by an exposure area irradiated outside of the wafer 1. Further, the upper face of the fine structure formed on the holding member 2 is arranged so as to have the same height as the surface of the wafer arranged in the exposure position.

In the present exemplary embodiment, when a water-repellant coat was applied on the surface forming the fine structure of the holding member 2, good water-repellency could be maintained over a long period even if irradiated with exposure light. Further, the area forming the fine structure does not have to be limited to the portion irradiated by the exposure light. This area may also be widely formed on the holding member 2 supporting the liquid. Moreover, the holding member may be replaceable.

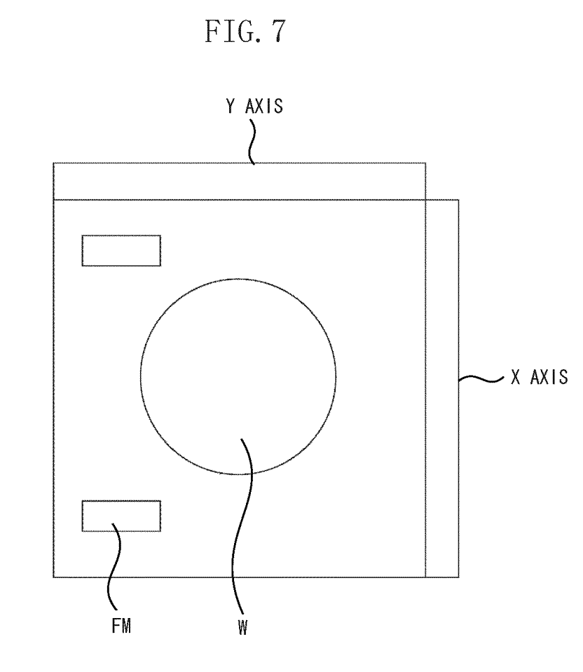

Next, a second exemplary embodiment according to the present invention will be described. FIG. 7 illustrates a plan view of a wafer stage. On the wafer stage, a reference mark FM or a measurement portion is arranged on the periphery of an area W where the wafer 1 is arranged. In the present exemplary embodiment, the above-described fine structure 20 is provided on the surface of a reference mark FW.

The reference mark FM is a mark used to align the mask and the wafer or to correct the positioning apparatus. On the wafer stage, members are provided, which serve as references for the X and Y axes respectively.

The reference mark FM is used in an immersed state during measurement under the projection optical system, and in a non-immersed state during measurement by a separately-provided correction apparatus. Therefore, after measurement under the projection optical system, the immersion liquid must be removed without any liquid remaining. Consequently, the reference mark FM needs to have water-repellency of a predetermined level or more.

Further, although measurement in the immersed state under the projection optical system can also be performed using the exposure light, this can lead to deterioration of the water-repellent film. However, when the fine structure 20 was formed on the surface of the reference mark FM and applied with a water-repellant coat, good water-repellency was exhibited over a long period of time.

Next, a third exemplary embodiment of the present invention will be described. In the present exemplary embodiment, the above-described fine structure 20 is provided on the surface of a nozzle.

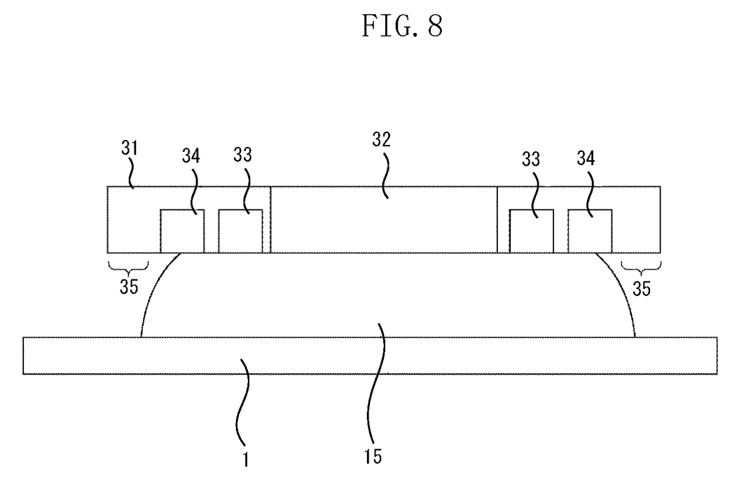

FIG. 8 is a schematic diagram illustrating near an immersion area formed between a projection optical system and a wafer. The immersion area vicinity includes a nozzle 31, a final lens 32 of the projection optical system, supply ports 33 of the liquid 15, recovery ports 34 of the liquid 15, and a surface 35 on which the fine structure 20 is formed. The immersion area is held within a fixed range due to the liquid 15 supplied from the supply ports 33 and recovered by the recovery ports 34.

It is desirable that the surface of the nozzle 31 on the external side of the recovery ports 34 is water-repellent. The reason for this is to prevent the liquid 15 from spreading out from the recovery ports 34 when liquid 15, which could not be recovered by the recovery ports 34, reaches the surface 35.

Further, the exposure light, which has passed through the lens 32 is scattered and reflected by the wafer 1, the surface of the lens 32, or nozzle 31. Even though the intensity is weak, such exposure light is irradiated on the surface of the nozzle 31. Therefore, if a water-repellent coating is applied on the nozzle 31 surface, the life of the water-repellency is still shortened.

Therefore, if the fine structure 20 is formed on the surface 35 of the nozzle 31 on the external side of the recovery port 34, good water-repellency can be maintained over a long period of time.

In the above exemplary embodiments, TC Coat™, which is a water-repellent film manufactured by Dupont, was used for the water-repellent coating material. However, the water-repellent coat is not limited to TC Coat. Other water-repellent coats, which may be used, include Teflon™, Cytop™, a fluoropolymer, polyethylene, polypropylene, polyacetal, wax, fluoroalkylsilane and the like.

Further, fluorocarbon, silicone, and hydrocarbon type water-repellent materials may typically alternatively be used. More specifically, the same effects can be obtained even by using some other water-repellant film or by forming a surface having protruded portions on the material itself.

Next, a method for manufacturing a device (semiconductor device, liquid crystal display device, etc.) as an embodiment of the present invention is described.

The semiconductor device is manufactured through a front-end process in which an integrated circuit is formed on a substrate such as a wafer, and a back-end process in which a product such as an integrated circuit chip is completed from the integrated circuit on the wafer formed in the front-end process. The front-end process includes a step of exposing the substrate coated with a photoresist to light using the above-described exposure apparatus of the present invention, and a step of developing the exposed substrate. The back-end process includes an assembly step (dicing and bonding), and a packaging step (sealing).

The liquid crystal display device is manufactured through a process in which a transparent electrode is formed. The process of forming a plurality of transparent electrodes includes a step of coating a substrate such as a glass substrate with a transparent conductive film deposited thereon with a photoresist, a step of exposing the substrate coated with the photoresist thereon to light using the above-described exposure apparatus, and a step of developing the exposed glass substrate.

The device manufacturing method of this embodiment has an advantage, as compared with a conventional device manufacturing method, in at least one of performance, quality, productivity and production cost of a device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-289998 filed Nov. 12, 2008, which is hereby incorporated by reference herein in its entirety.

What is claimed is:

1. A member used in an immersion exposure apparatus for exposing an image of a pattern of an original on a substrate via a liquid, and configured to be in contact with the liquid, the member comprising:
a base portion; and
a plurality of protruded portions provided on the base portion,
wherein a contact angle of a material of a surface of the protruded portions before the protruded portions are exposed with light from a light source is larger than 90 degrees with respect to the liquid, and
wherein, if the contact angle is θ, and a value obtained by dividing a sum of a surface area of a face of the base portion on which the plurality of protruded portions are provided and the surface area of the plurality of protruded portions, by an area of the face of the base portion on which the plurality of protruded portions are provided, is r, then
r>1/|cos θ| is satisfied.

2. The member according to claim 1, wherein a value obtained by dividing a width of the protruded portions by a period of the plurality of protruded portions is larger than 0 and less than or equal to 0.75.

3. The member according to claim 1, wherein the member is a holding member configured to hold the liquid,
wherein the holding member is arranged around a region on which the substrate is positioned when the substrate is exposed, and
wherein upper faces of the plurality of protruded portions are arranged so as to have a same height as a surface of the arranged substrate.

4. The member according to claim 1, wherein the member is provided on a stage configured to move the substrate, and
wherein the member is formed on a surface of a mark used to align the original and the substrate.

5. The member according to claim 1, wherein the member is formed on a surface of a nozzle having a supply port configured to supply the liquid or a recovery port configured to recover the liquid.

6. The member according to claim 1, wherein the member is replaceable.

7. An immersion exposure apparatus for exposing an image of a pattern of an original on a substrate via a liquid, the immersion exposure apparatus comprising:
the member according to claim 1;
an illumination optical system configured to illuminate the original using light from a light source; and
a projection optical system configured to project the image of the pattern of the illuminated original on the substrate.

8. A method for producing a device using an immersion exposure apparatus having an illumination optical system configured to illuminate an original using light from a light source, and a projection optical system configured to project an image of a pattern of the illuminated original on a substrate, the method comprising:
exposing the substrate using the immersion exposure apparatus;
developing the exposed substrate; and
forming the device using the developed substrate,
wherein the immersion exposure apparatus includes a member having a base portion and a plurality of protruded portions provided on the base portion, wherein a contact angle of a material of a surface of the protruded portions before the protruded portions are exposed with light from a light source is larger than 90 degrees with respect to the liquid, and wherein, if the contact angle is θ, and a value obtained by dividing a sum of a surface area of a face of the base portion on which the plurality of protruded portions are provided and the surface area of the plurality of protruded portions, by an area of the face of the base portion on which the plurality of protruded portions is provided, is r, then
r>1/|cos θ| is satisfied.
